(19) United States
(12) Patent Application Publication
(10) Pub. No.: US 2021/0014125 A1
(43) Pub. Date: Jan. 14, 2021

(54) NETWORK DESIGN DEVICE, NETWORK DESIGN METHOD, AND NETWORK DESIGN PROCESSING PROGRAM

(71) Applicant: NIPPON TELEGRAPH AND TELEPHONE CORPORATION, Tokyo (JP)

(72) Inventors: Erina TAKESHITA, Musashino-shi, Tokyo (JP); Hideo KAWATA, Musashino-shi, Tokyo (JP); Shinichi YOSHIHARA, Musashino-shi, Tokyo (JP)

(73) Assignee: NIPPON TELEGRAPH AND TELEPHONE CORPORATION, Tokyo (JP)

(21) Appl. No.: 16/977,966

(22) PCT Filed: Feb. 28, 2019
(86) PCT No.: PCT/JP2019/007803

§ 371 Date: Sep. 3, 2020

(30) Foreign Application Priority Data
Mar. 7, 2018 (JP) 2018-041244

(51) Int. Cl. H04L 12/24; H04L 12/26

(52) U.S. Cl. CPC H04L 41/145; H04L 43/0882; H04L 41/0826; H04L 41/12

(57) ABSTRACT

With a network design apparatus, a network design method, and a network design processing program, a network configuration is designed for a network in which a transfer apparatus is disposed for each of a plurality of communication hubs and the communication hubs are connected via a link by a link portion apparatus in the transfer apparatus. In design of a network configuration, a maximum total capacity of a link portion apparatus is calculated, and a combination candidate set of the link portion apparatus including only combination candidates of which a total capacity is equal to or smaller than the maximum total capacity is calculated.

### TECHNICAL FIELD

Embodiments of the present invention relate to a network design apparatus, a network design method, and a network design processing program.

### BACKGROUND ART

In recent years, with the diversification of network services, the number of services has increased and the requirements of a network for the services have diversified. Examples of the requirements for a network include an inter-end delay, band assurance, and conditions regarding redundancy. With the increase in the number of services or the diversification of the requirements, a cost of equipment of the network has increased.

In order to curb the increase in cost, for example, a network design in which a plurality of lines possessed by each network service are efficiently accommodated in a common infrastructure network is performed in NPL 1. Accordingly, economy of the network is further improved. In a method of NPL 1, an infrastructure network accommodating lines having different requirements for an inter-end delay is designed. Here, in the infrastructure network to be designed, a transfer apparatus that processes traffic of a path is disposed, and an interface is installed as a link portion apparatus in a link portion of the transfer apparatus. In NPL 1, a disposition and capacity of a transfer apparatuses at which a total cost value of interfaces of all transfer apparatuses on the infrastructure network is minimized is derived in the design of the infrastructure network. Thus, in the design of the infrastructure network, a design of a path accommodating each line and equipment design for designing the disposition or capacity of the transfer apparatus on the infrastructure network are performed simultaneously.

An overall flow in a process performed in NPL 1 is illustrated in FIG. 1. In a design of a network as in NPL 1, each line needs to be accommodated in a path satisfying requirements for an inter-end delay. Thus, in S′1, path candidates satisfying the requirements for the inter-end delay are calculated for each line, and a set of path candidates satisfying the requirements described above is a path candidate set, as illustrated in FIG. 1. The path candidate set consists of path candidates satisfying the requirements described above, and consists of the number of path candidates equal to or smaller than a designated number of path candidates. Here, the number of path candidates is a design parameter, and is designated by a designer.

Further, in NPL 1, interface combination candidates are calculated, and the calculated combination candidate set is used as an interface combination candidate set in S′2. In this case, combination candidates of interfaces that can be installed in the link portion of the transfer apparatus at each communication hub on the infrastructure network are calculated. The combination candidate set includes combination candidates of interfaces that can be installed in the link portion according to the designated number of interface combination candidates. Here, the number of combination candidates is a design parameter and is designated by a designer. Further, each of the interface combination candidates is a combination of zero or more interfaces. Further, certain interface combination candidates among the interface combination candidates may include the same type of interfaces.

In NPL 1, a total cost value of all the interfaces on the infrastructure network is used as an objective function, and an optimization problem in which an optimal network configuration for minimizing the objective function is derived is solved in S′3. A mathematical relationship obtained by formulating this optimization problem is shown below.

$$\begin{matrix}[ Math . 1 ] & \\ {arg min}_{\vec{x} , \vec{y}} 2 {\sum }_{e ∈ E} {\sum }_{j ∈ J} {y}_{j}^{e} \cdot {Ω}_{j}^{IF} & ( 1 ) \\ subject to , & \\ {\sum }_{i ∈ {I}^{v}} {x}_{i}^{v} = 1 , ∀ v ∈ V & ( 2 ) \\ {\sum }_{j ∈ J} {y}_{j}^{e} = 1 , ∀ e ∈ E & ( 3 ) \\ {y}_{j}^{e} \cdot {Ψ}_{j}^{IF} \geq {t}^{e} ( \vec{x} , \vec{d} , M ) & ( 4 )\end{matrix}$$

Further, matters indicated by, for example, parameters relevant to relationships (1)′ to (4)′ are as follows.

[Math. 2]
L=(l): Set of Communication hubs
E=(e): Set of Links between Communication hubs
V=(v): Set of lines
\vec{x}=(xᵢ^{v}): Line v selects path candidate i
\vec{y}=(yⱼ^{e}): Link e selects interface (IF) combination candidate j
Ωⱼ^{IF}: Cost value of IF combination candidate j
I^{v}: Path candidate set of line v
J: IF Combination candidate set
Ψⱼ^{IF}: Capacity of IF combination candidate j
\vec{d}=(dᵥ): Contracted band of line v
M: Connection Matrix (indicated by |L|X|E|) indicating connection form between communication hubs
t^{e}(\vec{x}, \vec{d}, M): Sum of contracted bands of link e (calculated on basis of \vec{x}, \vec{d}, M)

In the optimization problem of S′3, one path candidate is selected from the path candidate set for each line. For each line, a condition for selecting the path candidate from the path candidate set is shown in the relationships (2). Here, in the relationships (1) to (4), a variable x is a decision variable of the optimization problem. In each line, the variable x changes in correspondence to which path candidate has been selected from the path candidate set. Further, in the optimization problem, one combination candidate for a combination of interfaces is selected from the interface combination candidate set, for each link portion of the transfer apparatus, that is, for each link connecting each communication hub. For each link portion, a condition for selecting an interface combination candidate from a combination candidate set is shown in the relationships (3). Here, in the relationships (1) to (4), a variable y is a decision variable of the optimization problem. In each link portion, the variable y changes in correspondence to which interface combination candidate has been selected from the combination candidate set.

Further, in the optimization problem of S′3, capacity conditions of the relationships (4)′ are provided. That is, in each link (each link portion), a total contracted band being equal to or smaller than a total capacity of all interfaces constituting the combination candidates is provided as the capacity conditions. Thus, in the optimization problem, a combination candidate selected from an interface combination candidate set needs to satisfy the capacity conditions described above in each link.

In S′3, a total cost value of all interfaces on an infrastructure network shown in the relationships (1) is used as an objective function, and an optimization problem for minimizing the objective function is solved. By solving the optimization problem, an optimal path candidate is determined from the path candidates satisfying the conditions of the relationships (2) to (4), and an optimal combination candidate is determined from the interface combination candidates satisfying the conditions of the relationships (2) to (4).

In NPL 1, because the process is performed as described above, a network configuration with a smallest total cost value, that is, an optimal network configuration can be derived in an infrastructure network accommodating lines having different requirements for an inter-end delay. That is, for a network configuration including a path accommodating lines, and a disposition and capacity of each of transfer apparatuses and link portion apparatuses, an optimal network configuration can be derived from among a plurality of patterns.

### CITATION LIST

### Non Patent Literature

NPL 1: Erina Takeshita and Hideo Kawada, “Proposed Network Design Scheme Accommodating Various Paths”, Electronics, Information and Communication Engineers General Conference B-6-29, 2017.

### SUMMARY OF THE INVENTION

### Technical Problem

In NPL 1, in the calculation of the interface combination candidate of S′2, the combination candidates are calculated according to the number of interface combination candidates designated by the designer. Thus, unnecessary combination candidates are included in the combination candidate set. For example, combination candidates in which a total capacity of the interface is unnecessarily greater are included as unnecessary combination candidates. In the calculation of the optimization problem of S′3, an unnecessary pattern of a network configuration is also taken into account as an option due to the unnecessary combination candidates being included in the combination candidate set. Thus, derivation of the optimal network configuration is not performed efficiently.

The present invention has been made in view of the above circumstances, and provides a network design apparatus, a network design scheme, and a network design processing program capable of efficiently designing an optimal network configuration without taking an unnecessary pattern of a network configuration into account in calculation of an optimization problem.

### Means for Solving the Problem

To achieve the above object, a first aspect of the invention is a network design apparatus for designing a network configuration for a network in which a transfer apparatus is disposed at each of a plurality of communication hubs and the communication hubs are connected via a link by a link portion apparatus in the transfer apparatus, the network design apparatus including: an input reception unit configured to receive an input of topology information on a connection state between the communication hubs, line information regarding a plurality of lines accommodated in the network, apparatus information regarding the transfer apparatus disposed at the communication hub and the link portion apparatus in the transfer apparatus, and design parameter information regarding parameters used in the design; a first processing unit including a calculation unit configured to calculate a path candidate set of each line on the basis of the topology information, the line information, and the design parameter information; a second processing unit including a first calculation unit configured to calculate a maximum total capacity, the maximum total capacity being a maximum value of a total capacity of the link portion apparatuses in the link, on the basis of the topology information, the line information, the apparatus information, and a calculation result of the calculation unit of the first processing unit, and a second calculation unit configured to calculate a combination candidate set of the link portion apparatuses including combination candidates of which the total capacity is equal to or smaller than the maximum total capacity on the basis of the apparatus information and the calculation result of the first calculation unit; a third processing unit including a calculation unit configured to calculate, minimizing a total cost value in the overall network, an optimal path candidate of each line, and an optimal combination candidate of the link portion apparatus of each link on the basis of a calculation result of the calculation unit of the first processing unit and a calculation result of the first calculation unit of the second processing unit; and a generation unit configured to generate optimal network configuration information reflecting both the optimal path candidate of each line and the optimal combination candidate of the link portion apparatus of each link calculated by the calculation unit of the third processing unit.

A second aspect of the present invention is the network design apparatus according to the first aspect, wherein the first calculation unit of the second processing unit calculates a total contracted band for each link when each line is accommodated in a path with the largest number of hops among the path candidates, calculates, for each link, a total capacity of the link portion apparatuses corresponding to the total contracted band on the basis of the total contracted band for each link, and calculates a maximum value of the total capacity of the link portion apparatuses corresponding to the total contracted band as the maximum total capacity.

A third aspect of the present invention is the network design apparatus according to the second aspect, wherein the second calculation unit of the second processing unit calculates the combination candidate set on condition that a total capacity of the link portion apparatuses is different for each combination candidate in the combination candidate set of the link portion apparatus, and that the total capacity of the link portion apparatuses in each of the combination candidates of the combination candidate set of the link portion apparatus is equal to or smaller than the maximum total capacity.

A fourth aspect of the present invention is a network design processing program for causing a processor to function as each unit of the network design apparatus according to any one of the first to third aspects.

A fifth aspect of the present invention is a network design method for designing a network configuration for a network in which a transfer apparatus is disposed at each of a plurality of communication hubs and the communication hubs are connected via a link by a link portion apparatus in the transfer apparatus, the network design method comprising: acquiring topology information on a connection state between the communication hubs, line information regarding a plurality of lines accommodated in the network, apparatus information regarding the transfer apparatus disposed at the communication hub and the link portion apparatus in the transfer apparatus, and design parameter information regarding parameters used in the design; calculating a maximum total capacity, the maximum total capacity being a maximum value of a total capacity of the link portion apparatuses in the link, on the basis of the topology information, the line information, the apparatus information, and a calculation result of the calculation unit of the first processing unit; calculating a combination candidate set of the link portion apparatuses including combination candidates of which the total capacity is equal to or smaller than the maximum total capacity on the basis of the apparatus information and the calculation result for the maximum total capacity; calculating, minimizing a total cost value in the overall network, an optimal path candidate of each line, and an optimal combination candidate of the link portion apparatus of each link on the basis of a calculation result for the path candidate set for each line and a calculation result for the combination candidate set of the link portion apparatus; and generating network configuration information reflecting both the calculated optimal path candidate of each line and the calculated optimal combination candidate of the link portion apparatus of each link.

### Effects of the Invention

According to the first to fifth aspects of the present invention, a combination candidate set of link portion apparatuses including only combination candidates in which a total capacity of the link portion apparatuses is equal to or smaller than the maximum total capacity is calculated in the optimization problem for calculating the optimal network configuration minimizing the total cost value in the overall network. Thereby, it is possible to provide a network design apparatus, a network design method, and a network design processing program capable of efficiently designing an optimal network configuration without taking an unnecessary pattern of a network configuration into account in calculation of an optimization problem.

In the second and third aspects of the present invention, the maximum value of the total capacity of the link portion apparatuses corresponding to the total contracted band when each line is accommodated in the path with the largest number of hops among the path candidates is calculated as the maximum total capacity. A combination in which the total capacity of the link portion apparatuses is larger than the maximum total capacity is excluded from the combination candidates of the link portion apparatus.

Thus, in the optimization problem, the optimal path candidate, the optimal combination candidate of the link portion apparatuses, and the optimal combination candidate of the transfer apparatuses taking the cost of the transfer apparatuses into account are derived more appropriately.

Further, in the third aspect of the present invention, a combination in which the total capacity of the link portion apparatuses is larger than the maximum total capacity is excluded from the combination candidates of the link portion apparatus. Thus, in the optimization problem, the optimal path candidate, the optimal combination candidate of the link portion apparatuses, and the optimal combination candidate of the transfer apparatuses are derived more appropriately.

### BRIEF DESCRIPTION OF DRAWINGS

FIG. 1 is a flowchart illustrating an overall flow in a process performed in NPL 1.

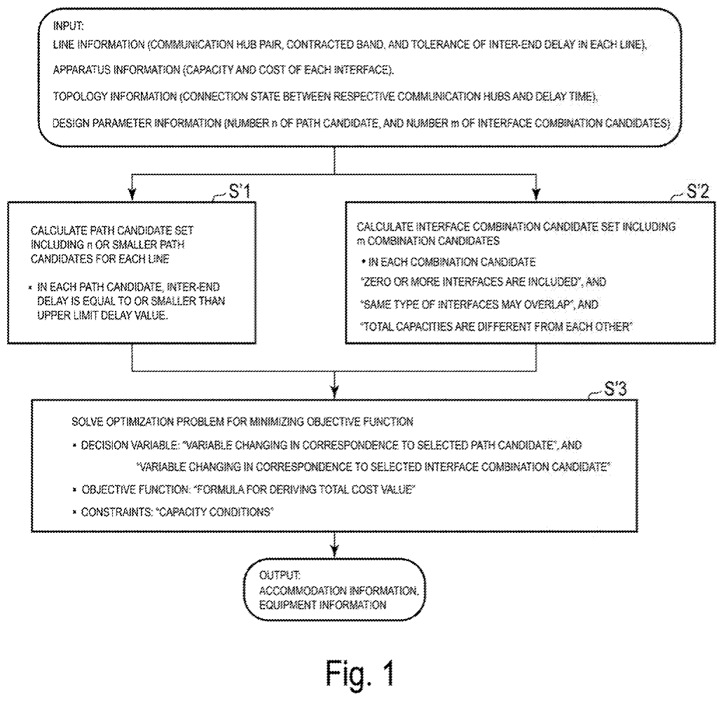

FIG. 2 is a block diagram illustrating an example of a network design apparatus according to a first embodiment of the present invention.

FIG. 3 is a flowchart illustrating an example of an operation procedure of the network design apparatus according to the first embodiment.

FIG. 4 is a flowchart illustrating an example of a procedure for calculating a path candidate set for any line in the first embodiment.

FIG. 5 is a flowchart illustrating an example of a procedure for calculating a maximum interface total capacity in the first embodiment.

FIG. 6 is a flowchart illustrating an example of a procedure for calculating an interface combination candidate set in the first embodiment.

FIG. 7 is a schematic diagram illustrating an example of a topology in an operation example in the first embodiment.

FIG. 8 is a schematic diagram illustrating a model example for use in the example of the topology of FIG. 6.

FIG. 9 is a schematic diagram illustrating an example of a switch in the operation example in the first embodiment.

FIG. 10 is a schematic diagram illustrating an example of disposition of switches in an infrastructure network illustrated in FIG. 7.

FIG. 11 is a schematic diagram illustrating an example of an optimal disposition example in a network in the operation example in the first embodiment.

### DESCRIPTION OF EMBODIMENTS

Hereinafter, embodiments of the present invention will be described with reference to the drawings. An L2 switch is used as an example of a network apparatus in each embodiment. As a transfer apparatus, any network apparatus can be used as long as the network apparatus is an apparatus in which a link portion apparatus such as an interface can be installed as equipment within the network apparatus, in addition to the L2 switch. For example, in each embodiment, a router or the like is available as the network apparatus (transfer apparatus).

### First Embodiment

In a first embodiment, an interface combination candidate set is calculated on the basis of a maximum interface total capacity (maximum total capacity). This allows an optimal solution to be efficiently searched for in optimization calculation.

Apparatus

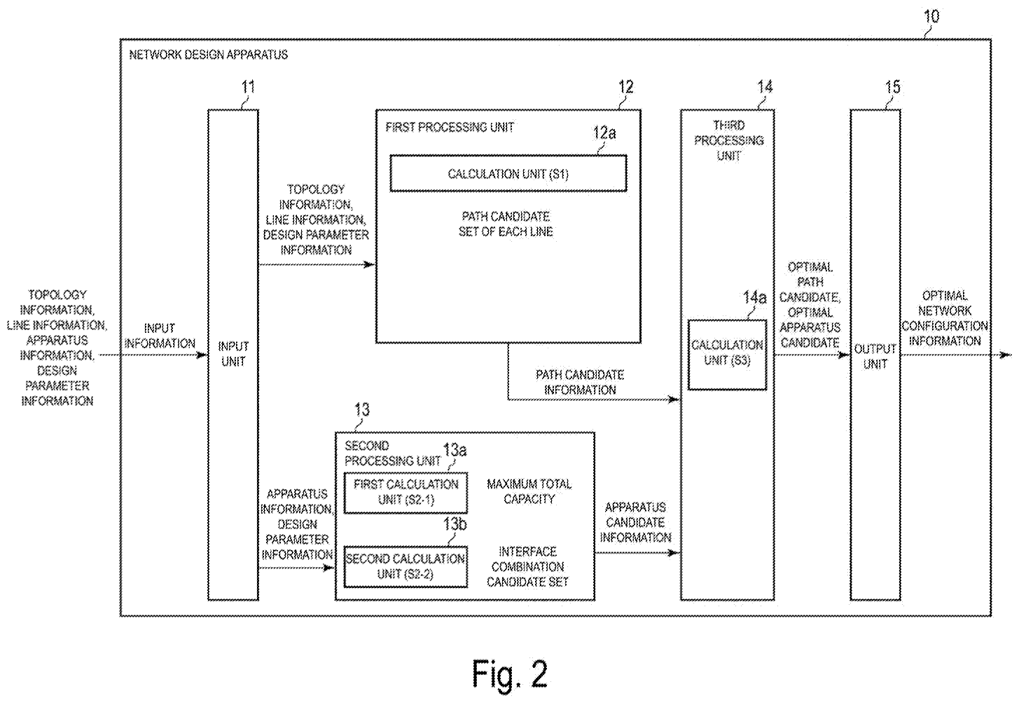

An example of a network design apparatus of the first embodiment is shown. FIG. 2 is a diagram illustrating an example of the network design apparatus according to the first embodiment of the present invention. The network design apparatus 10 outputs optimal network configuration information including optimal path information and optimal equipment information on the basis of input information. The network design apparatus 10 includes an input unit (input reception unit) 11, a first processing unit 12, a second processing unit 13, a third processing unit 14, and an output unit (generation unit) 15.

The first processing unit 12 includes a calculation unit 12a. The second processing unit 13 includes a first calculation unit 13a and a second calculation unit 13b. The third processing unit 14 includes a calculation unit 14a.

An input unit 11, which is an input reception unit, has a function of receiving input information input by a network designer, and outputting the input information to the first processing unit 12 and the second processing unit 13. The input information includes topology information, line information, apparatus information, and design parameter information. The topology information is information on a connection state between communication hubs on the infrastructure network. The line information is information on a plurality of lines accommodated in a network, and the plurality of lines are possessed by each network service. The apparatus information is information on a transfer apparatus disposed at each communication hub on the infrastructure network. Further, the apparatus information also includes information on a link portion apparatus such as an interface, which is installed on each transfer apparatus. The design parameter information is information on parameters that are used in design of a network.

The information including the topology information, the line information, and the design parameter information is input from the input unit 11 to the calculation unit 12a. The calculation unit 12a calculates a path candidate set from the information input from the input unit 11. The calculation unit 12a calculates the path candidate set of each line. The first processing unit 12 outputs the path candidate information including the path candidate set obtained by the calculation unit 12a. The path candidate information is output to the second processing unit 13 and the third processing unit 14.

Information including the topology information, the apparatus information, and the design parameter information is input from the input unit 11 to the first calculation unit 13a, and the path candidate information is input from the first processing unit 12 to the first calculation unit 13a. The first calculation unit 13a calculates a maximum interface total capacity from information input from the input unit 11 and the first processing unit 12. The maximum interface total capacity is output to the second calculation unit 13b.

Information including the design parameter information is input from the input unit 11 to the second calculation unit 13b, and the maximum interface total capacity is input from the first calculation unit 13a to the second calculation unit 13b. The second calculation unit 13b calculates the interface combination candidate set from information input from the input unit 11 and the first calculation unit 13a.

The second processing unit 13 outputs apparatus candidate information. The apparatus candidate information is output to the third processing unit 14. An apparatus candidate set includes the interface combination candidate set obtained by the second calculation unit 13b.

The path candidate information is input from the first processing unit 12 to the calculation unit 14a, and the apparatus candidate information is input from the second processing unit 13 to the calculation unit 14a. The calculation unit 14a calculates an optimal path candidate and an optimal apparatus candidate from the path candidate information and the apparatus candidate information to be input. The optimal apparatus candidate includes an optimal interface combination candidate. The third processing unit 14 outputs the optimal path candidate and the optimal apparatus candidate obtained by the calculation unit 14a to the output unit 15.

The optimal path candidate and the optimal apparatus candidate are input from the third processing unit 14 to the output unit 15, which is a generation unit. The output unit 15 generates network configuration information reflecting both the optimal path candidate and the optimal apparatus candidate on the basis of the information input from the third processing unit 14. The output unit 15 outputs the network configuration information reflecting the optimal path candidate and the optimal apparatus candidate, as optimal network configuration information, to a terminal apparatus to be operated by the network designer. The optimal network configuration information includes information on an optimal path accommodating each line and optimal equipment information regarding a switch and an interface disposed at each communication hub. The optimal equipment information regarding switches includes information on an optimal disposition of the switches and an optimal capacity of the switches. The optimal equipment information regarding interfaces includes information on an optimal disposition of the interfaces and an optimal capacity of the interfaces. The output unit (generation unit) 15 may store the generated optimal network configuration information in a storage medium or the like instead of outputting the optimal network configuration information to the terminal apparatus or the like.

Input Information

In the first embodiment, an example of the input information input to the input unit 11 of the network design apparatus 10 is shown. The input information is information input to the input unit 11 by a network designer. The input information that the network designer inputs to the input unit 11 of the network design apparatus 10 includes: (1) the topology information; (2) the line information; (3) the apparatus information; and (4) the design parameter information.

(1) The topology information includes (1-1) a connection matrix indicating a connection state between the communication hubs in the infrastructure network, and (1-2) a delay time in a link between the communication hubs.

(2) The line information includes (2-1) a starting point and an ending point of communications in each line, (2-2) a contracted band in each line, and (2-3) a tolerance of the inter-end delay in each line. (2-1) The starting point and the ending point of the communication in each line indicates a pair of communication hubs serving as end points of the line.

(3) The apparatus information includes information on each switch and information on each interface. Each interface constitutes a link portion apparatus in a switch disposed at the communication hub. The apparatus information includes (3-1) a traffic capacity of each interface, and (3-2) a cost value of each interface.

(4) The design parameter information includes (4-1) the number of path candidates (an upper limit value of the number of path candidates) per line.

Overview of Overall Flow and Each Process

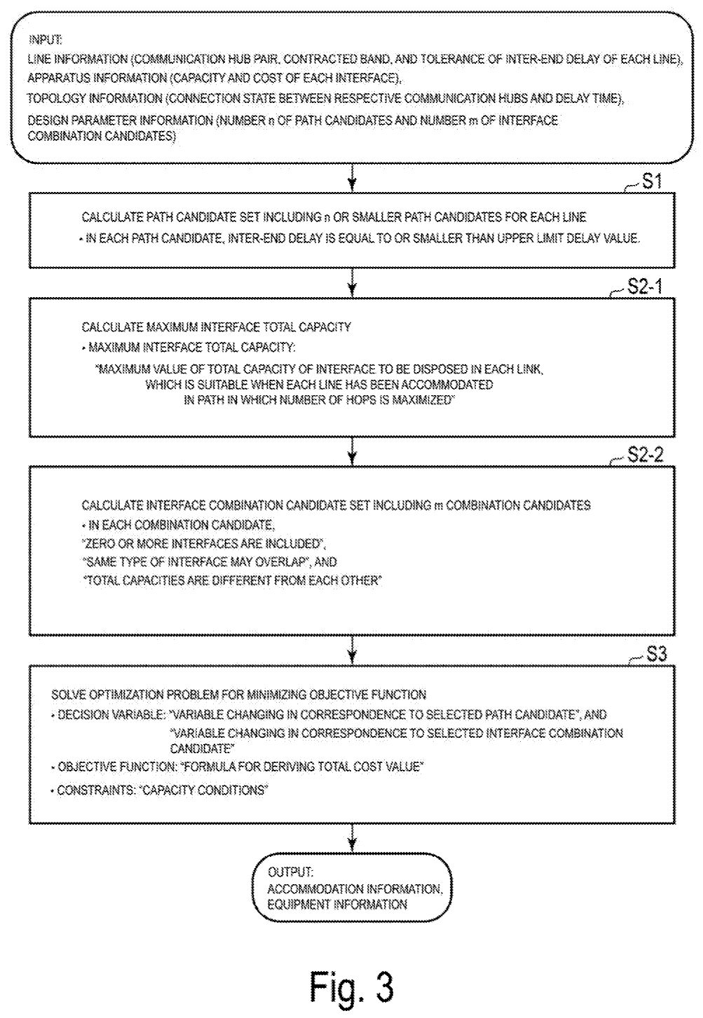

FIG. 3 is a flowchart illustrating an example of an operation procedure of the network design apparatus according to the first embodiment.

In S1, the calculation unit 12a of the first processing unit 12 calculates the path candidate set of each line. In S1, the calculation unit 12a calculates, for each line, an upper limit delay value, which is a threshold value for an inter-end delay. The calculation unit 12a calculates the path candidate set on the basis of the calculated upper limit delay value.

In S2-1, the first calculation unit 13a of the second processing unit 13 calculates the maximum interface total capacity (a maximum total capacity) after S1.

In S2-2, the second calculation unit 13b of the second processing unit 13 calculates the interface combination candidate set, after S2-1.

S3 is performed on the basis of calculation results in S1 and S2-2 after S-2. In S3, the calculation unit 14a of the third processing unit 14 calculates the optimal path candidate accommodating each line, and the optimal interface combination candidate to be disposed at a switch at each communication hub. The optimal network configuration is calculated on the basis of the optimal path candidate and the optimal interface combination candidate, that is, based on computation results in S3.

Details of Each Process

Next, details of S1 to S3 will be described.

Calculation of Path Candidate Set (S1)

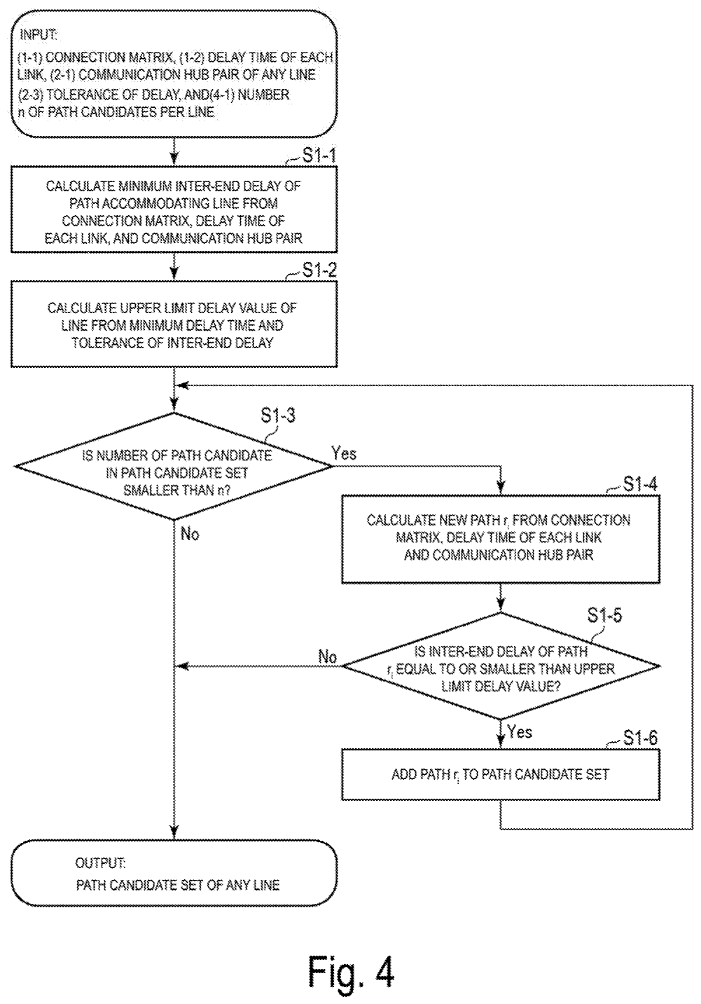

In the calculation of the path candidate set (S1), the calculation unit 12a of the first processing unit 12 calculates, for each line, an upper limit delay value, which is a threshold value of an inter-end delay, and the path candidate set. The upper limit delay value and the path candidate set are calculated from (1-1) the connection matrix, (1-2) the delay time of each link, (2-1) a communication hub pair, (2-3) the tolerance of the inter-end delay, and (4-1) the number of path candidates per line described above. FIG. 4 is a flowchart illustrating an example of a procedure for calculating a path candidate set for any line.

First, in S1-1, the calculation unit 12a of the first processing unit 12 calculates a minimum inter-end delay for a path accommodating any line. The minimum inter-end delay is a minimum value of the inter-end delay of the path accommodating the line. The calculation unit 12a calculates the minimum inter-end delay from (1-1) the connection matrix, (1-2) the delay time of each link, and (2-1) the communication hub pair of the line described above. For example, the calculation unit 12a creates a weighted undirected graph from (1-1) the connection matrix and (1-2) the delay time of each link. The calculation unit 12a calculates a shortest path and a sum of weights of the links in the shortest path in the created weighted undirected graph using a Dijkstra method. In this case, the sum of the weights of the links in the shortest path is calculated as the minimum inter-end delay.

Next, in S1-2, the calculation unit 12a of the first processing unit 12 calculates an upper limit delay value of the line. The calculation unit 12a calculates the upper limit delay value of the line from the minimum inter-end delay calculated in S1-1 and (2-3) the tolerance of the inter-end delay of the line. For example, when the minimum inter-end delay 1 and a numerical value i indicating the tolerance of the inter-end delay of the line have been defined, the calculation unit 12a performs calculation using lxi as a calculation relationship for calculating the upper limit delay value. The numerical value indicating the tolerance of the inter-end delay described above and a setting of the calculation relationship for the upper limit delay value are examples, and any value or calculation relationship can be set according to the embodiment. Accordingly, the upper limit delay value according to the tolerance of the inter-end delay can be calculated.

Next, in S1-3, the calculation unit 12a of the first processing unit 12 performs a determination from (4-1) the number n of path candidates per line. That is, the calculation unit 12a determines whether the number of path candidates already included in the path candidate set is smaller than n. When the number of path candidates already included in the path candidates is smaller than n (S1-3: Yes), the process proceeds to S1-4. On the other hand, when the number of path candidates already included in the path candidate set is n or greater (S1-3: No), the first processing unit 12 outputs the path candidate set including the already calculated path candidates. The process of S1 ends.

In S1-4, the calculation unit 12a of the first processing unit 12 calculates a new path rᵢ. In this case, the calculation unit 12a calculates the new path rᵢ from (1-1) the connection matrix, (1-2) the delay time of each link, and (2-1) the pair of communication hubs. Here, the calculation unit 12a calculates the new path in ascending order of the inter-end delay each time the process of S1-4 is repeated. In this case, a new path is calculated using a k-shortest path algorithm (see reference “Jin Y. Yen, ” Finding the K Shortest Loopless Paths in a Network”, Management Science, vol. 17, No. 11, pp. 712-716, 1971”). For example, it is assumed that a weighted graph G, a starting point s, and an ending point t have been assigned. In the k-shortest path algorithm, k paths that do not include a loop from s to t are searched for in ascending order of cost. Accordingly, in S1-4, the calculation unit 12a calculates the new path in ascending order of the inter-end delay using the k-shortest path algorithm.

Next, in S1-5, the calculation unit 12a of the first processing unit 12 calculates the inter-end delay of the path rᵢ calculated in S1-4. The calculation unit 12a determines whether the calculated inter-end delay is equal to or smaller than the upper limit delay value calculated in S1-2. When the inter-end delay of the new path rᵢ is equal to or smaller than the upper limit delay value (S1-5: Yes), the process proceeds to S1-6. On the other hand, when the inter-end delay of the new path rᵢ is greater than the upper limit delay value (S1-5: No), the first processing unit 12 outputs the path candidate set including the already calculated path candidate. Thus, the new path rᵢ calculated in S1-4 is not included in the path candidate set.

Next, the calculation unit 12a of the first processing unit 12 adds the path rᵢ calculated in S1-4 to the path candidate set as one path candidate in S1-6. The process returns to S1-3.

By S1-3 to S1-6 being performed as described above, the new path rᵢ is added to the path candidate set as the path candidate so long as the number of path candidates in the path candidate set are smaller than n and the inter-end delay of the new path rᵢ is equal to or smaller than the upper limit delay value. Thus, in the path candidate set of any line output in S1, the number of path candidates is equal to or smaller than n, and the inter-end delay of each path candidate is equal to or smaller than the upper limit delay value of the line. Here, n is the number of path candidates per line (an upper limit value of the number of path candidates), and is input by the network designer, as described above.

In the embodiment, the path candidate set is calculated in each line using the procedure of S1 described above. The path candidate set of each line calculated in S1 is used as an input of S2-1 and S3.

Calculation of Maximum Interface Total Capacity (S2-1)

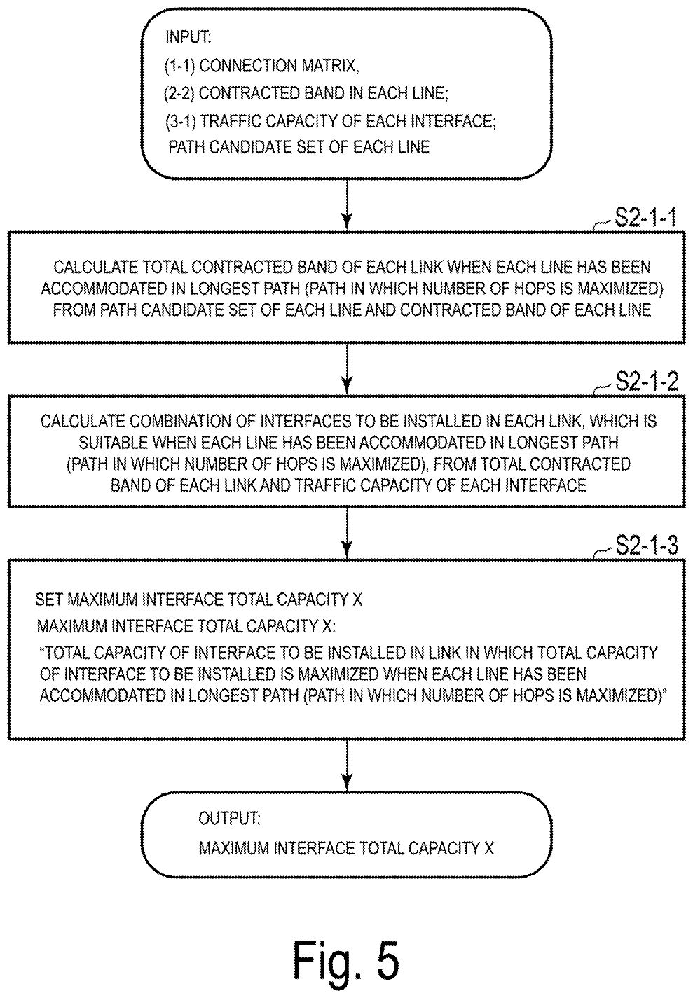

In calculation (S2-1) of a maximum interface total capacity (a maximum total capacity), the first calculation unit 13a of the second processing unit 13 calculates a maximum interface total capacity X. The first calculation unit 13a calculates the maximum interface total capacity X from (1-1) the connection matrix, (2-2) the contracted band in each line, and (3-1) the traffic capacity of each interface, and the path candidate set input from the first processing unit 12. The calculated maximum interface total capacity X is a maximum value of the total capacity of the interface provided in each link in the links included in the infrastructure network. FIG. 5 is a flowchart illustrating an example of a procedure for calculating the maximum interface total capacity X.

First, in S2-1-1, the first calculation unit 13a of the second processing unit 13 calculates the total contracted band of each link when each line has been accommodated in a longest path in the path candidate set, from (1-1) the connection matrix, (2-2) the contracted band in each line, (3-1) the traffic capacity of each interface, and the path candidate set calculated in S1. Here, a path length in each line becomes longest when the number of hops in the path is maximized. That is, the longest path is a path candidate in which the number of hops is maximized among the path candidates in the path candidate set.

In S2-1-1, the first calculation unit 13a calculates, for each link, a total contracted band when each line has been accommodated in the longest path, that is, when a path candidate in which the number of hops is maximized has been selected from the path candidate set. The total contracted band of the link in this case is the total number of contracted bands of the lines accommodated in the link when the path candidate in which the number of hops is maximized in each line has been selected.

Then, in S2-1-2, the first calculation unit 13a of the second processing unit 13 calculates, for each link, a combination of interfaces capable of most efficiently accommodating the total contracted band from (3-1) the traffic capacity of each interface and the total contracted band for each link calculated in S2-1-1. The combination of interfaces capable of most efficiently accommodating the total contracted band is a combination with the smallest total capacity among combinations of the interfaces satisfying the capacity conditions. In the combination of interfaces satisfying the capacity condition, the total capacity of the interfaces is equal to or greater than the total contracted band of the link.

Next, in S2-1-3, the first calculation unit 13a of the second processing unit 13 calculates the maximum interface total capacity X from the combination of the interfaces for each link calculated in S2-1-2. The first calculation unit 13a calculates, for each link, the total capacity of the interfaces in the calculated combination from the combination of the interfaces for each link calculated in S2-1-2. A maximum value among the total capacities of the interfaces calculated for each link is the maximum interface total capacity X. The maximum interface total capacity X is the largest value among the total capacities of the combinations of interfaces calculated for each link.

In the embodiment, the maximum interface total capacity X is calculated in the procedure of S2-1 described above. The maximum interface total capacity X calculated in S2-1 is used as an input of S2-2.

Calculation of Interface Combination Candidate Set (S2-2)

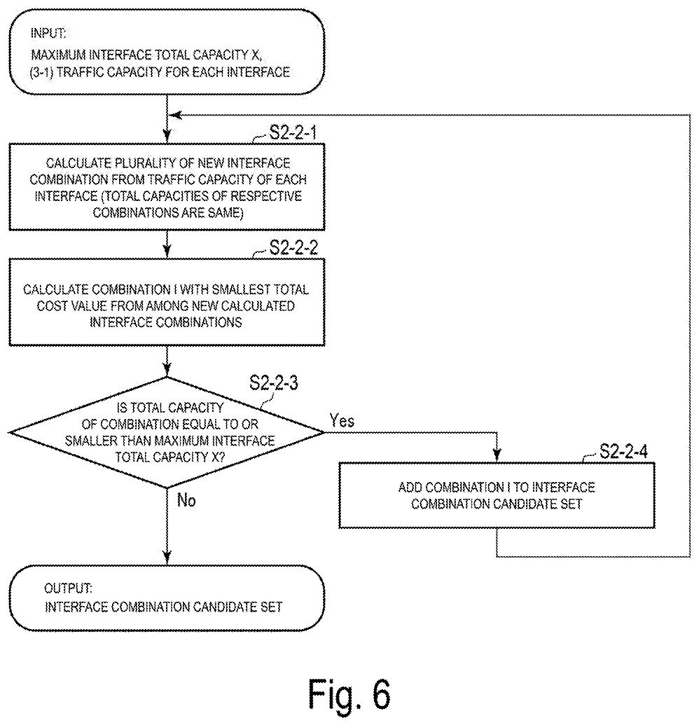

In calculation of an interface combination candidate set (S2-2), the second calculation unit 13b of the second processing unit 13 calculates the interface combination candidate set. The second calculation unit 13b calculates the interface combination candidate set from (3-1) the traffic capacity of each interface, (3-2) the cost value of each interface, and the maximum interface total capacity X input from the second calculation unit 13b. The calculated interface combination candidate set includes one or more combination candidates for an interface combination. Each combination candidate is a combination of zero or more interfaces, and in each combination candidate, a plurality of interfaces with the same traffic capacity may be overlapped and combined. Each combination candidate includes a combination in which there is no interface to used. FIG. 6 is a flowchart illustrating an example of a procedure for calculating the interface combination candidate set.

First, in S2-2-1, the second calculation unit 13b of the second processing unit 13 calculates one or more new combinations of interfaces. The second calculation unit 13b calculates a new combination from (3-1) the traffic capacity of each interface. In this case, the second calculation unit 13b may calculate a plurality of new combinations. In the plurality of new combinations to be calculated, however, total capacities, which are a sum of the traffic capacities of the interfaces, are the same as each other. Further, each new combination to be calculated is a combination of zero or more interfaces, and in each combination, a plurality of interfaces of the same type are allowed to overlap. The interfaces with the same traffic capacities correspond to the same types of interfaces. Further, each time the process of S2-2-1 is repeated, the second calculation unit 13b calculates the new combination in ascending order of the total capacity of the interfaces included in the combination.

Next, in S2-2-2, the second calculation unit 13b of the second processing unit 13 selects one combination I of the new combinations calculated in S2-2-1 from (3-2) the cost value of each interface. In this case, the second calculation unit 13b selects one combination I in which a total cost value that is a sum of the cost values of the interfaces is smallest, from among the combinations. The second calculation unit 13b adds the one combination I selected from among the new combinations to the interface combination candidate set.

Next, in S2-2-3, the second calculation unit 13b of the second processing unit 13 performs a determination from the total capacity of the interface in the combination I and the maximum interface total capacity X. That is, the second calculation unit 13b determines whether the total capacity of the interface in the combination I is equal to or smaller than the maximum interface total capacity X. When the total capacity of the interface of the combination I is equal to or smaller than the maximum interface total capacity X (S2-2-3: Yes), the process returns to S2-2-1. On the other hand, when the total capacity of the interface of the combination I is greater than the maximum interface total capacity X (S2-2-3: No), the second processing unit 13 outputs the already calculated interface combination candidate set.

By S2-2-1 to S2-2-3 being performed as described above, the total capacities of the respective combination candidates in the interface combination candidate set output in S2-2 are prime with respect to each other, and the total capacities of the respective combination candidates are equal to or smaller than the maximum interface total capacity X. That is, the combination candidates included in the interface combination candidate set differ in the total capacity of the interfaces. Further, each combination candidate is a combination of zero or more interfaces, and in each combination candidate, a plurality of interfaces of the same type are allowed to be overlap. Further, each combination candidate has a candidate number. The candidate number is set to a natural number between 1 and m. When the candidate number is greater, the total capacity of the interfaces included in the combination increases.

In the embodiment, the interface combination candidate set is calculated using the procedure of S2-2 described above. The interface combination candidate set calculated in S2-2 is used as an input of S3.

In the calculation (S3) of the optimal network configuration, the calculation unit 14a of the third processing unit 14 solves the optimization problem for minimizing the objective function, as in S′3 of NPL 1. That is, the calculation unit 14a uses a variable indicating which path candidate has been selected from the path candidate set as a decision variable. The decision variable indicating the selected path candidate is set for each line. Further, the calculation unit 14a uses a variable indicating which combination candidate has been selected from the interface combination candidate set, as the decision variable. The decision variable indicating the selected combination candidate is set for each link. The calculation unit 14a uses a relationship for deriving the total cost of all the interfaces of the infrastructure network as the objective function. The total cost of all interfaces changes depending on which combination candidate has been selected from the interface combination candidate set.

In the optimization problem of S3, constraints for selecting one path candidate in each line are provided, and the constraints are shown in the relationship (2), as in S′3 described above. The variable x is provided as a decision variable of the optimization problem, and the variable x indicates, for each line, the path candidate selected as a path to be accommodated from the path candidate set. Further, in the optimization problem, constraints for selecting one interface combination candidate is provided for each link, as in S′3 described above, and the constraints are shown in the relationship (3). The variable y is provided as the decision variable of the optimization problem, and the variable y indicates the combination candidate selected as a combination of interfaces to be disposed from the combination candidate set, for each link (for each link portion).

Further, in the optimization problem, the capacity conditions of the relationship (4) are provided as in S′3 described above. That is, in each link (each link portion), a capacity condition is that the total contracted band t^{e} is equal to or smaller than the total capacity Ψⱼ^{IF} of all the interfaces constituting the selected combination candidate. Thus, in the optimization problem, the combination candidate j selected from the interface combination candidate set needs to satisfy the capacity conditions described above in each link.

Here, the total contracted band t^{e} of each link is calculated on the basis of the path candidate selected for each line, the contracted band of each line, and the connection matrix indicating the connection state between the communication hubs. Here, the path candidate selected for each line is indicated by the variable x, which is the decision variable, in the relationship (1) to (4) described above. Further, the contracted band of each line is included in the input information described above, and corresponds to a parameter d, which is one of the parameters relevant to the relationship (1) to (4) described above. The connection matrix is included in the input information described above, and corresponds to a parameter M, which is one of the parameters relevant to the relationship (1) to (4). Thus, when the path candidate for each line is selected, the total contracted band t^{e} of each link is calculated from the line information and the topology information.

Further, in the optimization problem of S3, the total cost value of all the interfaces on the infrastructure network shown in the relationship (1) is used as the objective function, and an optimization problem for minimizing the objective function is solved, as in S′3 described above. In the relationship (1), yⱼ^{e}·Ωⱼ^{IF} indicates the total cost value of the interfaces in the selected combination candidate j for the link e. A sum of the total cost values calculated for each link, that is, a sum of the cost values of all the interfaces becomes the objective function. In the calculation of the total cost value of the interface total that is the objective function, the total cost value of the selected interface combination candidates for each link is calculated. The total cost values of all the links are summed, and a value obtained by doubling the sum is used as a value of the objective function. Doubling the sum is because the selected interface combination candidate is connected to both ends of each link.

The path candidate for each line and the interface combination candidate for each link for minimizing the objective function, which is the total cost value of all the interfaces, are derived by solving the optimization problem. That is, an optimal decision variable x is derived for each line, and an optimal decision variable y is derived for each link (each link portion). The derived path candidate for each line is the optimal path candidate for each line, and the derived interface combination candidate for each link is the optimal interface combination candidate for each link.

As described above, the calculation unit 14a of the third processing unit 14 calculates the optimal path candidates for each line and the optimal interface combination candidates for each link portion at each communication hub by solving the optimization problem. The third processing unit 14 outputs the calculated optimal path candidate and the calculated optimal interface combination candidates to the output unit 15.

In the embodiment, only a combination candidate of interfaces with a total capacity of the interfaces equal to or smaller than the maximum interface total capacity is included in the combination candidate set, as described above. Thus, in the calculation of the optimization problem of S3, it is possible to efficiently derive the optimal path candidate and the optimal interface combination candidate without taking an unnecessary pattern of a network configuration into account.

Operational Example

An example of an operation in the first embodiment divided into an example of input information and an example of an operation of each process will be described.

Example of Input Information

Topology Information

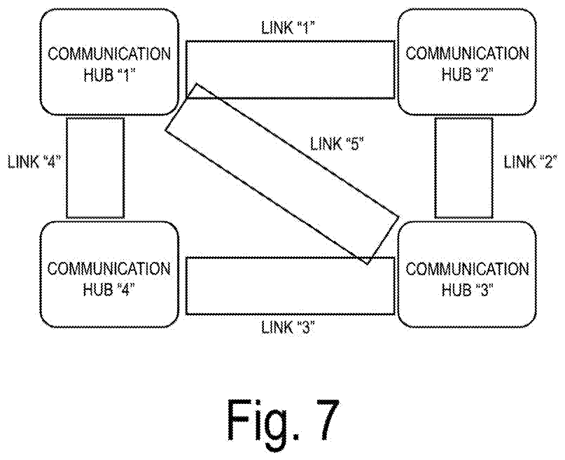

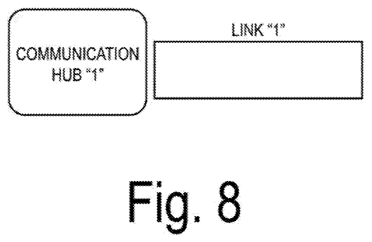

FIG. 7 is a diagram illustrating an example of the topology. FIG. 8 is a diagram illustrating a model example for use in the example of the topology in FIG. 7. That is, FIG. 8 is a diagram illustrating, for example, symbols used in the example in FIG. 7. In FIG. 8, communication hub “1” indicates a communication hub with the communication hub number of 1. Further, in FIG. 8, link “1” indicates a link with a link number of 1 and is connected to communication hub “1”.

FIG. 7 illustrates a connection state between communication hubs. Specifically, a connection state of communication hubs corresponding to communication hubs “1” to “4” via link “1” to link “5” is shown. The connection matrix M indicating the connection state between the communication hubs in the example of FIG. 7 is shown in the relationship (A) below.

$$\begin{matrix}[ Math . 3 ] & \\ M = ( \begin{matrix}1 & 0 & 0 & 1 & 1 \\ 1 & 1 & 0 & 0 & 0 \\ 0 & 1 & 1 & 0 & 1 \\ 0 & 0 & 1 & 1 & 0\end{matrix} ) & ( A )\end{matrix}$$

In the connection matrix M, each row corresponds to a communication hub, and each column corresponds to a link. When the link is connected to the communication hub, “1” is stored in a corresponding portion of the connection matrix M. On the other hand, when the link is not connected to the communication hub, “0” is stored in the corresponding portion of the connection matrix M.

Further, an example of the delay time in each link is shown as the topology information in Table 1 below. In Table 1, a delay time between the communication hubs is shown.

TABLE 1

| Link No. | Delay time |
|---|---|
| 1 | 2 |
| 2 | 1 |
| 3 | 2 |
| 4 | 1 |
| 5 | 4 |

Line Information

Next, an example of information on the line accommodated in the network is shown in Table 2 below.

TABLE 2

| Line | Communication | Contracted | Tolerance of |
|---|---|---|---|
| No. | hub pair | band | inter-end delay |
| 1 | 1, 3 | 10 | 1 |
| 2 | 1, 3 | 10 | 1 |
| 3 | 1, 3 | 10 | 0 |
| 4 | 1, 3 | 10 | 0 |

In an example of Table 2, in line “1” with the line number of “1”, communication of a contracted band “10” is performed between communication hub “1” and communication hub “3”. Line “1” has the tolerance of the inter-end delay of “1”. Here, in the example of Table 2, the tolerance of the inter-end delay is set to a value of 0 or 1. In this example, when the tolerance of the inter-end delay is 1, the tolerance is determined to be high, and a delay time of twice the inter-end delay of the shortest path is set as the upper limit delay value. On the other hand, when the tolerance of the inter-end delay is 0, the tolerance is determined to be low, and the inter-end delay of the shortest path is set as the upper limit delay value.

Apparatus Information

Next, an example of information on a switch that is a transfer apparatus (network apparatus) disposed at the communication hub and an interface (link portion apparatus) installed in the link portion of the switch will be described.

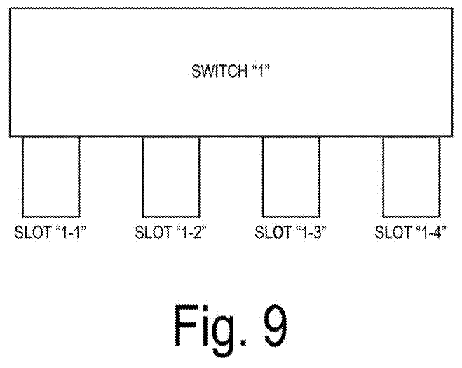

FIG. 9 illustrates an example of the switch. The switch in the example of FIG. 9 is a switch “1” with a switch number “1” and includes a slot “1-1”, a slot “1-2”, a slot “1-3”, and a slot “1-4”. The switch “1” receives data in which a destination is indicated. The switch “1” determines a slot to output the data on the basis of the destination indicated in the data. Accordingly, a link that outputs the data is determined.

The slot corresponds to a connection portion (link connection portion) between a communication hub and the link. Further, the slot accommodates an interface.

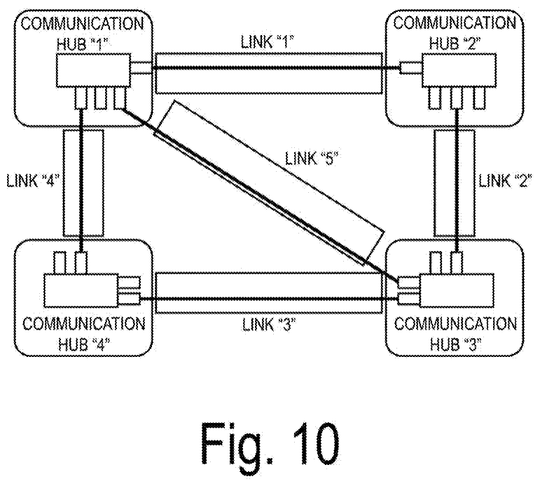

FIG. 10 illustrates an example of disposition of switches in the infrastructure network illustrated in FIG. 7. Thus, in FIG. 10, an example of a method of connecting switches in the topology of FIG. 7 is shown. In an example of FIG. 10, a switch is installed in communication hubs “1” to “4”. The slots of each switch are connected by a cable via a link, and the respective communication hubs are connected.

Next, an example of information on the switch is shown in Table 3 below.

TABLE 3

| Transfer | Number | Traffic Capacity |
|---|---|---|
| apparatus | of slots | per Slot |
| Switch “1” | 4 | 100 Gbit/s |
| Switch “2” | 8 | 100 Gbit/s |
| Switch “3” | 16 | 100 Gbit/s |

In an example of Table 3, information on switches with switch numbers of “1” to “3” is shown. In the example of Table 3, switch “1” with the switch number of “1” includes four slots. Further, in switch “1”, a total amount of traffic capacity that can be processed is 400 Gbit/s because a traffic capacity per slot is 100 Gbit/s. The total amount of traffic capacity is a sum of the traffic capacities of the slots provided in the switch.

Further, an example of information on the interface is shown in Table 4 below.

TABLE 4

| Link portion | Traffic | Cost | |
|---|---|---|---|
| apparatus | Capacity | value | Capacity |
| Interface “1” | 10 Gbit/s | 1 | 1 per slot |
| Interface “2” | 40 Gbit/s | 3 | 1 per slot |
| Interface “3” | 100 Gbit/s | 5 | 1 per slot |

In the example of Table 4, information on interfaces with interface numbers of “1” to “3” is shown. In the example of Table 4, in interface “1” with the interface number of “1”, a traffic capacity that can be processed is 10 Gbit/s. One interface “1” can be installed in one slot and has a cost value of 1.

Design Parameter Information

An example of the design parameter information is shown in Table 5 below. In the example of Table 5, the design parameter information includes the number of path candidates per line (an upper limit value of the number of path candidates).

TABLE 5

| | |
|---|---|
| Number of path candidates per line | 3 |

Example of Operation of Each Process

Calculation of Path Candidate Set (S1)

First, in S1-1, a minimum inter-end delay of each line is calculated. Table 6 below shows an example of a minimum inter-end delay of each line. In Table 6, for example, a minimum inter-end delay when the input information described above in the operation example has been input is shown.

TABLE 6

| Line | Communication | Minimum end- |
|---|---|---|
| No. | hub pair | to-end delay |
| 1 | 1, 3 | 3 |
| 2 | 1, 3 | 3 |
| 3 | 1, 3 | 3 |
| 4 | 1, 3 | 3 |

In an example of Table 6, in a communication hub pair of communication hub “1” and communication hub “3”, the inter-end delay has a minimum value in a path passing through link “1”, communication hub “2”, and link “2” and a path passing through link “4”, communication hub “4”, and link “3”. Thus, the inter-end delay in the path passing through link “1”, communication hub “2”, and link “2” or the inter-end delay in the path passing through link “4”, communication hub “4”, and link “3” is set as the minimum inter-end delay. From Table 1 described above, the delay time of link “1” is 2, and the delay time of link “2” is 1. Thus, the inter-end delay in the path passing through link “1”, communication hub “2”, and link “2” becomes “2+1=3”. Each line has a communication hub pair of communication hub “1” and communication hub “3”. Thus, in each line, the minimum inter-end delay is “3”.

Next, in S1-2, the upper limit delay value of each line is calculated. Table 7 below shows an example of the upper limit delay value of each line. In Table 7, for example, the upper limit delay value when the input information described above in the operation example is input and the minimum inter-end delay is calculated as in Table 6 of the operation example is shown.

TABLE 7

| Line | Communication | Tolerance of | Minimum end- | Upper limit |
|---|---|---|---|---|
| No. | hub pair | inter-end delay | to-end delay | delay value |
| 1 | 1, 3 | 1 | 3 | 6 |
| 2 | 1, 3 | 1 | 3 | 6 |
| 3 | 1, 3 | 0 | 3 | 3 |
| 4 | 1, 3 | 0 | 3 | 3 |

In an example of Table 7, line “1” and line “2” with the tolerance of the inter-end delay of 1 are determined to be high in the tolerance. Thus, in line “1” and line “2”, a delay time twice the minimum inter-end delay is set as the upper limit delay value, and the upper limit delay value is 6. On the other hand, line “3” and line “4” with the tolerance of the inter-end delay of 0 are determined to be low in the tolerance. Thus, in line “3” and line “4”, the minimum inter-end delay is set as the upper limit delay value, and the upper limit delay value is 3.

Next, in S1-3 to S1-6, path candidates in each line are calculated. When input information indicating an example of the input information is input, the path candidates are calculated on the basis of the number of path candidates of 3 per line set in Table 5. Thus, in each line, a maximum of three path candidates are calculated. Table 8 below shows an example of path candidates of each line to be calculated, and shows an example of the path candidate set. In Table 8, for example, the path candidate set when the input information described above is input in the operation example and the upper limit delay value is calculated as in Table 7 of the operation example is shown.

TABLE 8

| Line | Upper limit | Path | |
|---|---|---|---|
| No. | delay value | candidate | Use link |
| 1 | 6 | 1-1 | Link “1”, link “2” |
| | | 1-2 | Link “3”, link “4” |
| | | 1-3 | Link “5” |
| 2 | 6 | 2-1 | Link “1”, link “2” |
| | | 2-2 | Link “3”, link “4” |
| | | 2-3 | Link “5” |
| 3 | 3 | 3-1 | Link “1”, link “2” |
| | | 3-2 | Link “3”, link “4” |
| | | 3-3 | — |
| 4 | 3 | 4-1 | Link “1”, link “2” |
| | | 4-2 | Link “3”, link “4” |
| | | 4-3 | — |

In an example of Table 8, line “1” has an upper limit delay value of “6”. Thus, in line “1”, path “1-1” and “1-2” with the inter-end delay of “3” and path “1-3” with the inter-end delay of “4” are path candidates. On the other hand, line “3” has the upper limit delay value of “3”. Thus, in line “3”, only paths “3-1” and “3-2” with the inter-end delay of “3” are path candidates.

Calculation of Maximum Interface Total Capacity (S2-1)

Next, in S2-1, the maximum interface total capacity is calculated. In S2-1, a path in which the number of hops is maximized is selected randomly for each line. The total contracted band for each link is calculated when each line is accommodated in the selected path. In each link, a combination of interfaces suitable for the calculated total contracted band is calculated, and the total capacity of the interfaces in the calculated combination is calculated.

Table 9 shows an example of a total contracted band and total capacity calculated for each link. In Table 9, for example, calculation results when the input information described above in the operation example has been input are shown. In Table 9, calculation results when path candidate “1-1” is selected for line “1” as a path in which the number of hops in each line is maximized, path candidate “2-1” is selected for line “2”, path candidate “3-1” is selected for line “3”, and path candidate “4-1” is selected for line “4” in S2-1-1 are shown.

TABLE 9

| Link | Total contracted | Total |
|---|---|---|
| No. | band | capacity |
| 1 | 40 | 40 |
| 2 | 40 | 40 |
| 3 | 0 | 0 |
| 4 | 0 | 0 |
| 5 | 0 | 0 |

In an example of Table 9, the path candidate selected in lines “1” to “4” in S2-1-1 is a path that uses link “1” and link “2” and the number of hops is “2”. Thus, in S2-1-1, the path candidates selected in lines “1” to “4” are path candidates having the largest number of hops in the path candidate set. Further, in lines “1” to “4”, the contracted band is “10”. Thus, the total contracted band of link “1” and link “2” is “10*4=40”. On the other hand, the total contracted bands of links “3” to “5” are “0”.

In the example of Table 9, in link “1” and link “2”, the total contracted band calculated in S2-1-2 is “40.” Thus, in S2-1-2, a combination including four interfaces “1” with a capacity of “10 Gbit/s” and a combination including one interface “2” with a capacity of “40 Gbit/s” are calculated as combinations of interfaces that can most efficiently accommodate the total contracted band. The total number “40” of the capacities of the interfaces in the calculated combination is used as a total capacity of link “1” and link “2”.

In the example of Table 9, total contracted bands of links “3” to “5” are “0”. Thus, a combination including no interface is calculated as a combination of interfaces that can most efficiently accommodate the total contracted band. The total number “0” of the capacities of interfaces in the calculated combination is used as the total capacity of links “3” to “5”.

In S2-1-3, “40” that is the total capacity of link “1” and link “2” is calculated as the maximum interface total capacity.

Table 10 shows an example of a total contracted band and total capacity calculated for each link. In Table 10, calculation results in an example different from that for Table 9 are shown. In Table 10, calculation results when path candidate “1-1” is selected for line “1” as a path in which the number of hops in each line is maximized, path candidate “2-1” is selected for line “2”, path candidate “3-2” is selected for line “3”, and path candidate “4-2” is selected for line “4” in S2-1-1 are shown.

TABLE 10

| Link | Total contracted | Total |
|---|---|---|
| No. | band | capacity |
| 1 | 20 | 20 |
| 2 | 20 | 20 |
| 3 | 20 | 20 |
| 4 | 20 | 20 |
| 5 | 0 | 0 |

In the example of Table 10, the path candidate selected in lines “1” and “2” in S2-1-1 is a path that uses link “1” and link “2” and the number of hops is “2”. The path candidates selected in lines “3” and “4” are paths that use link “3” and link “4” and the number of hops is “2”. Thus, in S2-1-1, the path candidates selected in lines “1” to “4” are path candidates having the largest number of hops in the path candidate set. Further, in lines “1” to “4”, the contracted band is “10”. Thus, the total contracted band of link “1” and link “2” is “10*2=20” and the total contracted band of link “3” and link “4” is “10*2=20”. Further, the total contracted band of link “5” is “0”.

In the example of Table 10, in link “1”, link “2”, link “3”, and link “4”, the total contracted band calculated in S2-1-2 is “20.” Thus, in S2-1-2, a combination including two interfaces “1” with a capacity of “10 Gbit/s” is calculated as a combination of interfaces that can most efficiently accommodate the total contracted band. The total number “20” of the capacities of the interfaces in the calculated combination is used as a total capacity of link “1”, link “2”, link “3”, and link “4”.

In the example of Table 10, the total contracted band for link “5” is “0”. Thus, a combination including no interface is calculated as a combination of interfaces that can most efficiently accommodate the total contracted band. The total number “0” of the capacities of the interfaces in the calculated combination is used as a total capacity of link “5”.

In S2-1-3, “20”, which is the maximum value of the total capacity of link “1”, link “2”, link “3”, and link “4”, is calculated as the maximum interface total capacity.

Table 11 shows an example of a total contracted band and total capacity calculated for each link. In Table 11, calculation results in an example different from that for Table 9 and Table 10 are shown. In Table 11, calculation results when path candidate “1-1” is selected for line “1” as a path in which the number of hops in each line is maximized, path candidate “2-2” is selected for line “2”, path candidate “3-2” is selected for line “3”, and path candidate “4-2” is selected for line “4” in S2-1-1 are shown.

TABLE 11

| Link | Total contracted | Total |
|---|---|---|
| No. | band | capacity |
| 1 | 10 | 10 |
| 2 | 10 | 10 |
| 3 | 30 | 30 |
| 4 | 30 | 30 |
| 5 | 0 | 0 |

In an example of Table 11, the path candidate selected in line “1” in S2-1-1 is a path that uses link “1” and link “2” and the number of hops is “2”. The path candidates selected in lines “2”, “3”, and “4” are paths that use link “3” and link “4” and the number of hops is “2”. Thus, in S2-1-1, the path candidates selected in lines “1” to “4” are path candidates having the largest number of hops in the path candidate set. Further, in lines “1” to “4”, the contracted band is “10”. Thus, the total contracted band of link “1” and link “2” is “10*1=10” and the total contracted band of link “3” and link “4” is “10*3=30”. Further, the total contracted band of link “5” is “0”.

In the example of Table 11, in link “1” and link “2”, the total contracted band calculated in S2-1-2 is “10.” Thus, in S2-1-2, a combination including one interface “1” with a capacity of “10 Gbit/s” is calculated as a combination of interfaces that can most efficiently accommodate the total contracted band. The total number “10” of the capacities of the interfaces in the calculated combination is used as a total capacity of link “1” and link “2”.

Further, in the example of Table 11, in link “3” and link “4”, the total contracted band calculated in S2-1-2 is “30.” Thus, in S2-1-2, a combination including three interfaces “1” with a capacity of “10 Gbit/s” is calculated as a combination of interfaces that can most efficiently accommodate the total contracted band. The total number “30” of the capacities of the interfaces in the calculated combination is used as a total capacity of link “3” and link “4”.

Further, in the example of Table 11, the total contracted band of link “5” is “0.” Thus, a combination including no interface is calculated as a combination of interfaces that can most efficiently accommodate the total contracted band. The total number “0” of the capacities of the interfaces in the calculated combination is used as a total capacity of link “5”.

In S2-1-3, “30” that is a total capacity of link “3” and link “4” is calculated as the maximum interface total capacity.

Calculation of Interface Combination Candidate Set (S2-2)

Table 12 below shows an example of an interface combination candidate set to be calculated. In Table 12, for example, the interface combination candidate set when the input information described above is input in the operation example and the calculation results shown in the example of Table 9 are obtained in S2-1 is shown.

TABLE 12

| Candidate No. of interface | | Total | Total cost |
|---|---|---|---|
| combination candidate | Combination | capacity | value |
| 1 | — | 0 | 0 |
| 2 | Interface “1” | 10 | 1 |
| 3 | Interface “1” * 2 | 20 | 2 |
| 4 | Interface “1” * 3 | 30 | 3 |
| 5 | Interface “2” | 40 | 3 |

In the calculation of the interface combination candidate set, one or more new combinations of interfaces are calculated each time S2-2-1 is repeated. In S2-2-1, a total capacity of interfaces included in the new combination to be calculated is different each time, and a new combination is calculated in ascending order of the total capacity each time the process of S2-2-1 is repeated. Thus, in S2-2-1, the interfaces included in the new combination to be calculated form different combinations each time.

For example, in an example in which the maximum interface total capacity calculated in S2-1 is “40”, a case in which combinations of interfaces with a total capacity of “40 Gbit/s” are calculated in S2-2-1 will be described. In this case, a combination in which four interfaces with a capacity of “10 Gbit/s” are included, and a combination in which one interface with a capacity of “40 Gbit/s” is included are calculated as the combinations of interfaces with a total capacity of “40 Gbit/s”.

In S2-2-2, a combination with the smallest total cost value among the new combinations calculated in S2-2-1 is calculated. Here, the total cost value of a combination including four interfaces with a capacity of “10 Gbit/s” is “1*4=4”, and the total cost value of a combination including one interface with a capacity of “40 Gbit/s” is “3*1=3”. That is, the combination including one interface with a capacity of “40 Gbit/s” among the combinations calculated in S2-2-1 has the smallest total cost value. Thus, in S2-2-2, the combination including one interface with a capacity of “40 Gbit/s” is calculated as the combination with the smallest total cost value.

When the input information described above in the operation example is input, the process of S2-2-3 is performed on the basis of the combination including one interface with a capacity of “40 Gbit/s” and the maximum interface total capacity “40” set in S2-1. That is, in S2-2-3, it is determined whether the total capacity of the interfaces in the calculated combination is equal to or greater than the maximum interface total capacity of “40”. Here, the total capacity of the combination including one interface with a capacity of “40 Gbit/s” is “40 Gbit/s”. Thus, in S2-2-3, the combination calculated in S2-2-2 is added as a combination candidate to the interface combination candidate set. S2-2-1 is performed again.

Next, a case in which a combination of interfaces with the total capacity of “50 Gbit/s” is calculated in S2-2-1 will be described. In this case, the total capacity of the interface combination calculated in S2-2-2 is “50 Gbit/s”.

In S2-2-3, it is determined whether the total capacity of the interfaces in the calculated combination is equal to or greater than the maximum interface total capacity of “40”. Here, the total capacity of the combination calculated in S2-2-2 is “50 Gbit/s”. Thus, in S2-2-3, the interface combination candidate set is output, and S2-2 ends. That is, the combination of which the total capacity of the combination calculated in S2-2-2 is “50 Gbit/s” is not added to the interface combination candidate. Further, candidate numbers “1” to “10” are set for the combination candidates.

Further, Table 13 below shows an example of an interface combination candidate set to be calculated. In Table 13, for example, the interface combination candidate set when the input information described above is input in the operation example and the calculation results shown in the example of Table 10 are obtained in S2-1 is shown.

TABLE 13

| Candidate No. of interface | | Total | Total cost |
|---|---|---|---|
| combination candidate | Combination | capacity | value |
| 1 | — | 0 | 0 |
| 2 | Interface “1” | 10 | 1 |
| 3 | Interface “1” * 2 | 20 | 2 |

As shown in Table 13, the combination candidate set of interfaces with different total capacities is calculated in ascending order of the total capacity, as in the example in Table 12.

Table 14 below shows an example of the interface combination candidate set to be calculated. In Table 14, for example, the interface combination candidate set when the input information described above in the operation example has been input and the calculation results shown in the example of Table 11 have been obtained in S2-1 is shown.

TABLE 14

| Candidate No. of interface | | Total | Total cost |
|---|---|---|---|
| combination candidate | Combination | capacity | value |
| 1 | — | 0 | 0 |
| 2 | Interface “1” | 10 | 1 |
| 3 | Interface “1” * 2 | 20 | 2 |
| 4 | Interface “1” * 3 | 30 | 3 |

As shown in Table 14, the combination candidate set of interfaces with different total capacities is calculated in ascending order of the total capacity, as in the example in Table 12.

Calculation of Optimal Network Configuration (S3)

In S3, the optimization problem described above is solved. Table 15 illustrates an example of the optimal path candidates of each line calculated in the optimization problem. For example, in the operation example, when S1 has been performed as described above, and S2-1 and S2-2 have been performed as shown in the examples in Table 9 and Table 12, the optimal path candidate for each line is calculated as in Table 15. Table 16 shows an example of the optimal interface combination candidate for each link calculated in the optimization problem. For example, in the operation example, when S1 has been performed as described above, and S2-1 and S2-2 have been performed as shown in the examples in Table 9 and Table 12, the optimal interface combination candidate for each link is calculated as in Table 16.

TABLE 15

| Line | No. of selected |
|---|---|
| No. | path candidate |
| 1 | 1-1 |
| 2 | 2-1 |
| 3 | 3-1 |
| 4 | 4-1 |

TABLE 16

| Link | Candidate No. of selected |
|---|---|
| No. | interface combination candidate |
| 1 | 5 |
| 2 | 5 |
| 3 | 1 |
| 4 | 1 |
| 5 | 1 |

That is, when S1 and S2 have been performed as described above in the operation example, path “1-1” is calculated as the optimal path candidate for line “1”, path “2-1” calculated as the optimal path candidate for line “2”, path “3-1” calculated as the optimal path candidate for line “3”, and path “4-1” calculated as the optimal path candidate for line “4”.

Further, in S3, a total contracted band to for each link is calculated on the basis of the selected path candidates of each line. In the example of Table 15, a path candidate using link “1” and link “2” is calculated as an optimal path in lines “1” to “4”. Thus, for example, four lines with the contracted band of “10 Gbit/s” are accommodated in link “1” and link “2”. Thus, in link “1” and link “2”, the total contracted band is “10*4=40 Gbit/s”. Further, lines are not accommodated in link “3”, link “4”, and link “5”. Thus, the total contracted band of link “3”, link “4”, and link “5” is “0”.

As shown in Table 16, when S1 and S2 have been performed as described above in the operation example, the combination candidate with the candidate number of “5” is calculated as an optimal interface combination candidate for links “1” and “2”, and the combination candidate “1” is calculated as an optimal interface combination candidate for links “3” to “5”. As shown in the relationship (4), in each link, the total capacity of the interfaces in the calculated combination candidate is equal to or greater than the total contracted band.

In link “1”, the combination candidate with the candidate number of “5” is calculated as the optimal interface combination candidate. Thus, one interface “2” is installed in each link portion to which link “1” is connected. Thus, at communication hub “1” and communication hub “2”, one interface “2” is installed in each link portion corresponding to link “1”.

Similarly, because in link “2”, the combination candidate with the candidate number of “5” is calculated as the optimal interface combination candidate, one interface “2” is installed in each link portion corresponding to link “1” at communication hub “2” and communication hub “3”.

Further, in links “3” to “5”, the combination candidate with the candidate number of “1” is calculated as the optimal interface combination candidate. Thus, no interface is installed in the link portion to which links “3” to “5” are connected.

Thus, a total of four interfaces “2” with a cost value of 3 are installed on the infrastructure network including links “1” to “5”. Thus, a sum of the cost values of all the interfaces on the infrastructure network is “2*(3+3+0+0+0)=12”, which is a minimum value.

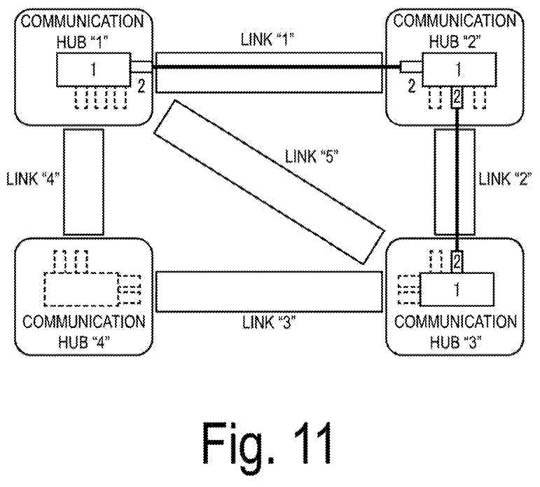

An optimal network configuration, that is, an optimal disposition example in the network is generated and output on the basis of the optimal path candidate of each line and the optimal interface combination candidate of each link derived as described above. FIG. 11 illustrates an example of an optimal disposition in a network. FIG. 11 illustrates a disposition example when the optimal path candidates of each line have been calculated as in Table 15 and the optimal interface combination candidates of each link have been calculated as in Table 16.

In the optimal disposition illustrated in FIG. 11, a switch (transfer apparatus) is disposed only at the communication hubs “1” to “3”, and a switch (transfer apparatus) is not disposed at communication hub “4”. In each of communication hubs “1” to “3”, an interface of a type of interface “2” is installed only in the link portions of link “1” and link “2”. An interface is not installed in the link portions of links “3” to “5”.

Further, Table 17 shows an example of the optimal path candidate for each line calculated in the optimization problem. For example, in the operation example, when S1 has been performed as described above and S2-1 and S2-2 have been performed as shown in the examples in Table 10 and Table 13, the optimal path candidate for each line is calculated as in Table 17. Table 18 shows an example of the optimal interface combination candidate for each link calculated in the optimization problem. For example, in the operation example, when S1 has been performed as described above and S2-1 and S2-2 have been performed as shown in the examples in Table 10 and Table 13, the optimal interface combination candidate for each link is calculated as in Table 18.

TABLE 17

| Line | No. of selected |
|---|---|
| No. | path candidate |
| 1 | 1-1 |
| 2 | 2-1 |
| 3 | 3-2 |
| 4 | 4-2 |

TABLE 18

| Link | Candidate No. of selected |
|---|---|
| No. | interface combination candidate |
| 1 | 3 |
| 2 | 3 |
| 3 | 3 |
| 4 | 3 |
| 5 | 1 |

That is, when S1, S2-1, and S2-2 have been performed as described above in the operation example, path “1-1” is calculated as the optimal path candidate for line “1”, path “2-1” is calculated as the optimal path candidate for line “2”, path “3-2” is calculated as the optimal path candidate for line “3”, and path “4-2” is calculated as the optimal path candidate for line “4”.

Further, in S3, a total contracted band to for each link is calculated on the basis of the selected path candidates of each line. In the example of Table 17, a path candidate using link “1” and link “2” is calculated as an optimal path in lines “1” and “2”. Thus, for example, two lines for which the contracted band is “10 Gbit/s” are accommodated in link “1” and link “2”. Thus, in link “1” and link “2”, the total contracted band is “10*2=20 Gbit/s”. Further, in lines “3” and “4”, a path candidate using link “3” and link “4” is calculated as an optimal path. Thus, for example, two lines with the contracted band of “10 Gbit/s” are accommodated in link “3” and link “4”. Thus, in link “3” and link “4”, the total contracted band is “10*2=20 Gbit/s”. Further, no line is accommodated in link “5”. Thus, the total contracted band of link “5” is “0”.

Further, as shown in Table 18, when S1, S2-1, and S2-2 have been performed as described above in the operation example, the combination candidate with the candidate number of “3” is calculated as an optimal interface combination candidate for links “1” to “4”, and the combination candidate with the candidate number of “1” is calculated as an optimal interface combination candidate for link “5”. As shown in the relationship (4), in each link, the total capacity of the interfaces in the calculated combination candidate is equal to or greater than the total contracted band.

In link “1”, the combination candidate with the candidate number of “3” is calculated as the optimal interface combination candidate. Thus, two interfaces “1” are installed in each link portion to which link “1” is connected. Thus, two interfaces “1” are installed in each link portion corresponding to link “1” at communication hub “1” and communication hub “2”.

Similarly, in link “2”, the combination candidate with the candidate number of “3” is calculated as the optimal interface combination candidate. Thus, two interfaces “1” are installed in each link portion to which link “2” is connected. Thus, in communication hub “2” and communication hub “3”, two interfaces “1” are installed in each link portion corresponding to link “2”.

Similarly, in link “3”, the combination candidate with the candidate number of “3” is calculated as the optimal interface combination candidate. Thus, two interfaces “1” are installed in each link portion to which link “3” is connected. Thus, at communication hub “3” and communication hub “4”, two interfaces “1” are installed in each link portion corresponding to link “3”.

Similarly, in link “4”, the combination candidate with the candidate number of “3” is calculated as the optimal interface combination candidate. Thus, two interfaces “1” are installed in each link portion to which link “4” is connected. Thus, at communication hub “4” and communication hub “1”, two interfaces “1” are installed in each link portion corresponding to link “4”.

Further, in link “5”, the combination candidate with the candidate number of “1” is calculated as the optimal interface combination candidate. Thus, no interface is installed in the link portion to which link “5” is connected.

Accordingly, a combination of interfaces with a total cost value of 2 in links “1” to “4” is installed on the infrastructure network including links “1” to “5”. Thus, a sum of the cost values of all the interfaces on the infrastructure network is “2*(2+2+2+2+0)=16”, which is a minimum value.

Further, Table 19 shows an example of the optimal path candidate for each line calculated in the optimization problem. For example, in the operation example, when S1 has been performed as described above, and S2-1 and S2-2 have been performed as shown in the examples in Table 11 and Table 14, the optimal path candidate for each line is calculated as in Table 19. Table 20 shows an example of the optimal interface combination candidate for each link calculated in the optimization problem. For example, in the operation example, when S1 has been performed as described above, and S2-1 and S2-2 have been performed as shown in the examples in Table 11 and Table 14, the optimal interface combination candidate for each link is calculated as in Table 20.

TABLE 19

| Line | No. of selected |
|---|---|
| No. | path candidate |
| 1 | 1-1 |
| 2 | 2-2 |
| 3 | 3-2 |
| 4 | 4-2 |

TABLE 20

| Link | Candidate No. of selected |
|---|---|
| No. | interface combination candidate |
| 1 | 2 |
| 2 | 2 |
| 3 | 4 |
| 4 | 4 |
| 5 | 1 |

That is, when S1, S2-1, and S2-2 have been performed as described above in the operation example, path “1-1” is calculated as the optimal path candidate for line “1”, path “2-2” is calculated as the optimal path candidate for line “2”, path “3-2” is calculated as the optimal path candidate for line “3”, and path “4-2” is calculated as the optimal path candidate for line “4”.

Further, in S3, a total contracted band t^{e} of each link is calculated on the basis of the selected path candidates of each line. In the example of Table 19, a path candidate using link “1” and link “2” is calculated as an optimal path in line “1”. Thus, for example, one line with the contracted band of “10 Gbit/s” is accommodated in link “1” and link “2”. Thus, in link “1” and link “2”, a total contracted band is “10*1=10 Gbit/s”. Further, in lines “2” to “4”, a path candidate using link “3” and link “4” is calculated as an optimal path. Thus, for example, three lines with the contracted band of “10 Gbit/s” are accommodated in link “3” and link “4”. Thus, in link “3” and link “4”, the total contracted band is “10*3=30 Gbit/s”. Further, no line is accommodated in link “5”. Thus, the total contracted band of link “5” is “0”.

Further, as shown in Table 20, when S1, S2-1, and S2-2 have been performed as described above in the operation example, the combination candidate with the candidate number of “2” is calculated as an optimal interface combination candidate for links “1” and “2”, the combination candidate with the candidate number of “4” is calculated as an optimal interface combination candidate for links “3” and “4”, and the combination candidate with the candidate number of “1” is calculated as an optimal interface combination candidate for link “5”. As shown in the relationship (4), in each link, the total capacity of the interfaces in the calculated combination candidate is equal to or greater than the total contracted band.

In link “1”, the combination candidate with the candidate number of “2” is calculated as the optimal interface combination candidate. Thus, one interface “1” is installed in each link portion to which link “1” is connected. Thus, at communication hub “1” and communication hub “2”, one interface “1” is installed in each link portion corresponding to link “1”.

Similarly, in link “2”, the combination candidate with the candidate number of “2” is calculated as the optimal interface combination candidate. Thus, one interface “1” is installed in each link portion to which link “2” is connected. Thus, at communication hub “2” and communication hub “3”, two interfaces “1” are installed in each link portion corresponding to link “2”.

In link “3”, the combination candidate with the candidate number of “4” is calculated as the optimal interface combination candidate. Thus, three interfaces “1” are installed in each link portion to which link “3” is connected. Thus, at communication hub “3” and communication hub “4”, three interfaces “1” are installed in each link portion corresponding to link “3”.

Similarly, in link “4”, the combination candidate with the candidate number of “4” is calculated as the optimal interface combination candidate. Thus, three interfaces “1” are installed in each link portion to which link “4” is connected. Thus, at communication hub “4” and communication hub “1”, three interfaces “1” are installed in each link portion corresponding to link “4”.

In link “5”, the combination candidate with the candidate number of “1” is calculated as the optimal interface combination candidate. Thus, no interface is installed in the link portion to which link “5” is connected.

Accordingly, a combination of interfaces with a total cost value of 1 in links “1” and “2” is installed, and a combination of interfaces with a total cost value of 3 in links “3” and “4” is installed on the infrastructure network including links “1” to “5”. Thus, a sum of the cost values of all the interfaces on the infrastructure network is “2*(1+1+3+3+0)=16”, which is a minimum value.

(Operations and Effects)

Here, the design parameter information is set with (4-1) the number of path candidates per line as 3, as in the operation example described above. It is assumed that there are four lines and five links in the infrastructure network, as in the operation example described above.

When the input information or the like are set as described above, a comparative example in which a designer sets the number of interface combination candidates is considered. In the comparative example, a case in which the number of interface combination candidates is set to “10” is considered. In the comparative example, the configuration that the network may take in the optimization calculation has a “3⁴×10⁵=810000” pattern. Further, a configuration of a network satisfying the capacity conditions and minimizing the objective function needs to be derived from the network configuration with the “810000” pattern.

On the other hand, in the embodiment, the number of interface combination candidates calculated in the optimization problem is calculated on the basis of the path candidate information capable of accommodating each line and the interface combination in which each link can accommodate each line. Thus, when the input information or the like is set as described above and the total capacity of each link is calculated as shown in the example of Table 9, the configuration that the network may take in the optimization calculation has a “3⁴×5⁵=253125” pattern, and the number of patterns in the configuration that the network can take is greatly reduced from that in the comparative example. A configuration minimizing the objective function is derived from the network configuration with the “253125” pattern.

Further, when the input information or the like is set as described above and the total capacity of each link is calculated as shown in the example of Table 10, the configuration that the network may take in the optimization calculation has a “3⁴×3⁵=19683” pattern, and the number of patterns in the configuration that the network can take is greatly reduced from that in the comparative example. A configuration minimizing the objective function is derived from the network configuration with the “19683” pattern. Further, in the example of Table 10, a total cost value of an optimal solution is greater, but the number of patterns is smaller than in the example in Table 9.

Further, when the input information or the like is set as described above and the total capacity of each link is calculated as shown in the example of Table 11, the configuration that the network may take in the optimization calculation has a “3⁴×4⁵=82944” pattern, and the number of patterns in the configuration that the network can take is greatly reduced from that in the comparative example. A configuration minimizing the objective function is derived from the network configuration with the “82944” pattern. Further, in the example of Table 11, a total cost value of an optimal solution is greater, but the number of patterns is smaller than in the example in Table 9.

Accordingly, in the embodiment, it is possible to reduce a search range by reducing the number of interface combination candidates to be calculated in the optimization problem. This allows a computation time to be shortened. That is, in the optimization calculation, it is possible to reduce the search range in the optimization calculation by excluding unnecessary patterns that may not be calculated in the optimization calculation among patterns in the configuration that the network can take, and limiting the number of search candidates to a required number.

A scheme described in each embodiment is stored in a recording medium such as a magnetic disk (a Floppy (registered trademark) disk, a hard disk, or the like), an optical disc (a CD-ROM, a DVD, an MO, or the like), a semiconductor memory (a ROM, a RAM, a flash memory, or the like) or transferred by a communication medium for distribution, as a program (a software means) that can be executed by a calculator (a computer). The program stored in the medium also includes a setting program for causing a software means (including not only an execution program but also a table or data structure), which will be executed in a calculator, to be configured within the calculator. A calculator implementing the present apparatus executes the above-described process by loading the program recorded on the recording medium or constructing a software means using the setting program in some cases, and controlling an operation using the software means. The recording medium referred to herein is not limited to a recording medium for distribution, and includes a storage medium such as a magnetic disk or a semiconductor memory provided inside the calculator or in a device connected via a network.

Further, the present invention is not limited to the embodiments, and it is possible to make various modifications without departing from the gist of the present invention. Further, the embodiments may be implemented in appropriate combination, and in this case, effects of the combination can be obtained. Further, various inventions are included in the above embodiment and can be extracted by a combination selected from a plurality of configuration requirements that are disclosed. For example, in a case in which the problem can be solved and the effects can be obtained even when some of all the configuration requirements shown in the embodiment are removed, a configuration in which such configuration requirements have been removed can be extracted as an invention.

### REFERENCE SIGNS LIST

10: Network design apparatus
11 Input unit
12 First processing unit
12a Calculation unit
13 Second processing unit
13a First calculation unit
13b Second calculation unit
14 Third processing unit
14a Calculation unit
15 Output unit

1. A network design apparatus for designing a network configuration for a network in which a transfer apparatus is disposed at each of a plurality of communication hubs and the communication hubs are connected via links by a link portion apparatus in the transfer apparatus, the network design apparatus comprising:
an input reception unit configured to receive an input of topology information on a connection state between the communication hubs, line information regarding a plurality of lines accommodated in the network, apparatus information regarding the transfer apparatus disposed at the communication hub and the link portion apparatus in the transfer apparatus, and design parameter information regarding parameters used in the design;
a first processing unit including a calculation unit configured to calculate a path candidate set of each of the lines on the basis of the topology information, the line information, and the design parameter information;
a second processing unit including a first calculation unit configured to calculate a maximum total capacity, the maximum total capacity being a maximum value of a total capacity of the link portion apparatuses in the link, on the basis of the topology information, the line information, the apparatus information, and a calculation result of the calculation unit of the first processing unit, and a second calculation unit configured to calculate a combination candidate set of the link portion apparatuses including combination candidates of which the total capacity is equal to or smaller than the maximum total capacity on the basis of the apparatus information and the calculation result of the first calculation unit;
a third processing unit including a calculation unit configured to calculate, minimizing a total cost value in the overall network, an optimal path candidate of each of the lines, and an optimal combination candidate of the link portion apparatus of each of the links on the basis of a calculation result of the calculation unit of the first processing unit and a calculation result of the first calculation unit of the second processing unit; and
a generation unit configured to generate optimal network configuration information reflecting both the optimal path candidate of each of the line and the optimal combination candidate of the link portion apparatus of each of the link calculated by the calculation unit of the third processing unit.

2. The network design apparatus according to claim 1, wherein the first calculation unit of the second processing unit
calculates a total contracted band for each of the links when each of the lines is accommodated in a path with a largest number of hops among the path candidates,
calculates, for each of the links, a total capacity of the link portion apparatuses corresponding to the total contracted band on the basis of the total contracted band for each of the links, and
calculates a maximum value of the total capacity of the link portion apparatuses corresponding to the total contracted band as the maximum total capacity.

3. The network design apparatus according to claim 2,
wherein the second calculation unit of the second processing unit calculates the combination candidate set on condition that a total capacity of the link portion apparatuses is different for each of the combination candidates in the combination candidate set of the link portion apparatus, and that the total capacity of the link portion apparatuses in each of the combination candidates of the combination candidate set of the link portion apparatus is equal to or smaller than the maximum total capacity.

4. A non-transitory computer readable medium which stores a network design processing program for designing a network configuration for a network in which a transfer apparatus is disposed at each of a plurality of communication hubs and the communication hubs are connected via links by a link portion apparatus in the transfer apparatus, the network design processing program causing a processor to
acquire topology information on a connection state between the communication hubs, line information regarding a plurality of lines accommodated in the network, apparatus information regarding the transfer apparatus disposed at the communication hub and the link portion apparatus in the transfer apparatus, and design parameter information regarding parameters used in the design;
calculate a path candidate set of each of the lines on the basis of the topology information, the line information, and the design parameter information;
calculate a maximum total capacity, the maximum total capacity being a maximum value of a total capacity of the link portion apparatuses in the link, on the basis of the topology information, the line information, the apparatus information, and a calculation result for the path candidate set for each of the lines;
calculate a combination candidate set of the link portion apparatuses including combination candidates of which the total capacity is equal to or smaller than the maximum total capacity on the basis of the apparatus information and the calculation result for the maximum total capacity;
calculate, minimizing a total cost value in the overall network. an optimal path candidate of each of the lines, and an optimal combination candidate of the link portion apparatus of each of the links on the basis of a calculation result for the path candidate set for each of the lines and a calculation result for the combination candidate set of the link portion apparatus; and
generate network configuration information reflecting both the calculated optimal path candidate of each of the lines and the calculated optimal combination candidate of the link portion apparatus of each of the links.

5. A network design method for designing a network configuration for a network in which a transfer apparatus is disposed at each of a plurality of communication hubs and the communication hubs are connected via links by a link portion apparatus in the transfer apparatus, the network design method comprising:
acquiring topology information on a connection state between the communication hubs, line information regarding a plurality of lines accommodated in the network, apparatus information regarding the transfer apparatus disposed at the communication hub and the link portion apparatus in the transfer apparatus, and design parameter information regarding parameters used in the design;
calculating a path candidate set of each of the lines on the basis of the topology information, the line information, and the design parameter information;
calculating a maximum total capacity, the maximum total capacity being a maximum value of a total capacity of the link portion apparatuses in the link, on the basis of the topology information, the line information, the apparatus information, and a calculation result for the path candidate set for each of the lines;
calculating a combination candidate set of the link portion apparatuses including combination candidates of which the total capacity is equal to or smaller than the maximum total capacity on the basis of the apparatus information and the calculation result for the maximum total capacity;
calculating, minimizing a total cost value in the overall network. an optimal path candidate of each of the lines, and an optimal combination candidate of the link portion apparatus of each of the links on the basis of a calculation result for the path candidate set for each of the lines and a calculation result for the combination candidate set of the link portion apparatus; and
generating network configuration information reflecting both the calculated optimal path candidate of each of the lines and the calculated optimal combination candidate of the link portion apparatus of each of the links.
